(19) United States
(12) Patent Application Publication
(10) Pub. No.: US 2026/0046797 A1
(43) Pub. Date: Feb. 12, 2026

(54) SYNCHRONIZATION SIGNAL BLOCK CONFIGURATION FOR MACHINE-TYPE-COMMUNICATION DEVICES

(71) Applicant: QUALCOMM Incorporated, San Diego, CA (US)

(72) Inventors: Kangqi LIU, San Diego, CA (US); Le LIU, San Jose, CA (US); Gabi SARKIS, San Diego, CA (US); Yan ZHOU, San Diego, CA (US); Mostafa KHOSHNEVISAN, San Diego, CA (US); Alberto RICO ALVARINO, San Diego, CA (US); Weimin DUAN, San Diego, CA (US); Diana MAAMARI, San Diego, CA (US)

(21) Appl. No.: 18/797,248

(22) Filed: Aug. 7, 2024

(51) Int. Cl. H04W 56/00; H04W 8/22; H04W 24/08

(52) U.S. Cl. CPC H04W 56/0015; H04W 8/22; H04W 24/08

(57) ABSTRACT

Methods, systems, and devices for wireless communications are described. A machine-type-communication (MTC) UE may monitor for a synchronization signal block (SSB) from a network entity. The SSB may be formatted in accordance with a capability of the MTC UE such that the MTC UE may receive the SSB. In some examples, the MTC UE may receive the SSB within a quantity of physical resource blocks (PRBs) supported by the MTC UE. The SSB may include a primary synchronization signal (PSS), a secondary synchronization signal (SSS), and a physical broadcast channel (PBCH). To account for the capability of the MTC UE, the network entity may transmit the PSS and the SSS over two symbols, where each symbol includes a portion of the PSS or the SSS in accordance with the capability of the MTC UE.

### FIELD OF TECHNOLOGY

The following relates to wireless communications, including synchronization signal block configuration for machine-type-communication devices.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include monitoring a first set of resources for a synchronization signal block (SSB) based on a capability of the UE, where the first set of resources is different from a second set of resources allocated for one or more wireless devices having a different capability than the capability of the UE, decoding system information associated with the SSB in accordance with the first set of resources, and performing a cell acquisition procedure based on the system information.

A UE for wireless communications is described. The UE may include one or more memories storing processor executable code, and one or more processors coupled with the one or more memories. The one or more processors may individually or collectively be operable to execute the code to cause the UE to monitor a first set of resources for an SSB based on a capability of the UE, where the first set of resources is different from a second set of resources allocated for one or more wireless devices having a different capability than the capability of the UE, decode system information associated with the SSB in accordance with the first set of resources, and perform a cell acquisition procedure based on the system information.

Another UE for wireless communications is described. The UE may include means for monitoring a first set of resources for an SSB based on a capability of the UE, where the first set of resources is different from a second set of resources allocated for one or more wireless devices having a different capability than the capability of the UE, means for decoding system information associated with the SSB in accordance with the first set of resources, and means for performing a cell acquisition procedure based on the system information.

A non-transitory computer-readable medium storing code for wireless communications is described. The code may include instructions executable by one or more processors to monitor a first set of resources for an SSB based on a capability of the UE, where the first set of resources is different from a second set of resources allocated for one or more wireless devices having a different capability than the capability of the UE, decode system information associated with the SSB in accordance with the first set of resources, and perform a cell acquisition procedure based on the system information.

In some examples of the method, UEs, and non-transitory computer-readable medium described herein, monitoring the first set of resources for the SSB may include operations, features, means, or instructions for monitoring a first subset of resources corresponding to a first SSB occasion, the first subset of resources spanning one or more resource blocks associated with frequencies greater than a center frequency of a synchronization raster point for SSB monitoring, where a quantity of the first subset of resources may be based on the capability of the UE and monitoring a second subset of resources corresponding to a second SSB occasion, the second subset of resources spanning one or more resource blocks associated with frequencies less than the center frequency of the synchronization raster point for SSB monitoring, where a quantity of the second subset of resources may be based on the capability of the UE.

Some examples of the method, UEs, and non-transitory computer-readable medium described herein may further include operations, features, means, or instructions for receiving a portion of a primary synchronization signal (PSS), a portion of a conjugate PSS, a portion of a secondary synchronization signal (SSS), and a portion of a conjugate SSS based on the monitoring, where the portion of the PSS and the portion of the conjugate PSS include a complete PSS, and where the portion of the SSS and the portion of the conjugate SSS include a complete SSS.

Some examples of the method, UEs, and non-transitory computer-readable medium described herein may further include operations, features, means, or instructions for receiving an PSS via a set of multiple contiguous symbols of the SSB, receiving an SSS via a first set of multiple non-contiguous symbols of the SSB, and receiving a physical broadcast channel (PBCH) via a second set of multiple non-contiguous symbols of the SSB different from the first set of multiple non-contiguous symbols.

Some examples of the method, UEs, and non-transitory computer-readable medium described herein may further include operations, features, means, or instructions for receiving an PSS via a first set of multiple contiguous symbols of the SSB, receiving an SSS via a second set of multiple contiguous symbols of the SSB, and receiving a PBCH via a third set of multiple contiguous symbols of the SSB, where the first set of multiple contiguous symbols, the second set of multiple contiguous symbols, and the third set of multiple contiguous symbols may be different.

Some examples of the method, UEs, and non-transitory computer-readable medium described herein may further include operations, features, means, or instructions for receiving an PSS via a first set of multiple contiguous symbols of the SSB, receiving an SSS via a second set of multiple contiguous symbols of the SSB, and receiving a PBCH via a set of multiple non-contiguous symbols of the SSB, where the first set of multiple contiguous symbols may be different from the second set of multiple contiguous symbols.

Some examples of the method, UEs, and non-transitory computer-readable medium described herein may further include operations, features, means, or instructions for receiving a PBCH via a set of multiple non-contiguous symbols of the SSB, where at least a portion of the set of multiple non-contiguous symbols may be separated within an SSB occasion of the SSB by one or more empty symbols.

Some examples of the method, UEs, and non-transitory computer-readable medium described herein may further include operations, features, means, or instructions for receiving a PBCH via a set of multiple non-contiguous symbols of the SSB and a set of multiple contiguous symbols of the SSB, where the set of multiple contiguous symbols occupies a half of an SSB occasion of the SSB in time.

In some examples of the method, UEs, and non-transitory computer-readable medium described herein, monitoring the first set of resources may include operations, features, means, or instructions for monitoring six resource blocks at a subcarrier spacing (SCS) of 15 kilohertz (kHz) for the SSB based on the capability of the UE.

In some examples of the method, UEs, and non-transitory computer-readable medium described herein, a synchronization raster point of the SSB may be based on a bandwidth associated with the SSB.

In some examples of the method, UEs, and non-transitory computer-readable medium described herein, a synchronization raster point of the SSB may be based on the capability of the UE.

In some examples of the method, UEs, and non-transitory computer-readable medium described herein, the UE may be a machine type communication (MTC) UE.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports synchronization signal block (SSB) configuration for machine-type-communication (MTC) devices in accordance with one or more aspects of the present disclosure.

FIG. 2 shows an example of a wireless communications system that supports SSB configuration for MTC devices in accordance with one or more aspects of the present disclosure.

FIG. 3 shows an example of a SSB pattern that supports SSB configuration for MTC devices in accordance with one or more aspects of the present disclosure.

FIG. 4 shows an example of SSB patterns that supports SSB configuration for MTC devices in accordance with one or more aspects of the present disclosure.

FIG. 5 shows an example of SSB patterns that supports SSB configuration for MTC devices in accordance with one or more aspects of the present disclosure.

FIG. 6 shows an example of a process flow that supports SSB configuration for MTC devices in accordance with one or more aspects of the present disclosure.

FIGS. 7 and 8 show block diagrams of devices that support SSB configuration for MTC devices in accordance with one or more aspects of the present disclosure.

FIG. 9 shows a block diagram of a communications manager that supports SSB configuration for MTC devices in accordance with one or more aspects of the present disclosure.

FIG. 10 shows a diagram of a system including a device that supports SSB configuration for MTC devices in accordance with one or more aspects of the present disclosure.

FIG. 11 shows a flowchart illustrating methods that support SSB configuration for MTC devices in accordance with one or more aspects of the present disclosure.

### DETAILED DESCRIPTION

Some wireless communications systems may support multiple types of devices, with each device having various device capabilities. In an example, a Long-Term-Evolution (LTE) system may support multiple types of user equipment (UE), including internet-of-things (IoT) UEs. In some cases, the IoT UEs may be machine-type-communication (MTC) UEs, which may be associated with a reduced capability relative to other IoT UEs. For example, MTC UEs may support a reduced bandwidth for communications. In another example, a Fifth Generation (5G) network may not support MTC UEs. For example, because of the reduced capabilities associated with MTC UEs, the MTC UE may be unable to receive a synchronization signal block (SSB) formatted for and transmitted in the 5G network. For example, a network entity may transmit an SSB over a greater number of physical resource blocks (PRBs) that are supported by the MTC UE, which may prevent the UE from receiving and decoding the entire SSB. For example, the MTC UE may only be able to decode signaling (e.g., a primary synchronization signal (PSS), a secondary synchronization signal (SSS), a physical broadcast channel (PBCH), or any combination thereof) that is received via PRBs that are within the bandwidth of the MTC UE.

Various aspects of the present disclosure relate to SSB configuration for MTC devices. A UE may receive an SSB from a network entity. The UE may be an MTC UE. The SSB may be formatted such that the UE may detect and receive the SSB. In some examples, the network entity may transmit the SSB over 20 PRBs. During a first SSB occasion (e.g., an even SSB occasion), the UE may monitor a first quantity of PRBs (e.g., 6 PRBs, as supported by the UE) that are above a synchronization raster point. During a second SSB occasion (e.g., an odd SSB occasion), the UE may monitor a second quantity of PRBs (e.g., another 6 PRBs) that are below the synchronization raster point. To compensate for the reduced capability of the UE, the SSB may duplicate and conjugate the PSS and the SSS such that the UE may receive the PSS and the SSS over two symbols each, where the first quantity of PRBs and the second quantity of PRBs associated with one symbol each includes a half of the PSS or the SSS.

In some other examples, the network entity may transmit the SSB over 6 PRBs. To compensate for the reduced capability of the UE, the SSB may include the PSS and the SSS in multiple symbols. For example, the UE may receive the PSS and the SSS over two symbols each, where one symbol includes half of the PSS or the SSS. In some cases, the network entity may transmit SSS in two contiguous symbols of the SSB to minimize the effects of a phase difference between the two symbols including the SSS. Alternatively, the network entity may format the SSB in accordance with a reduced density SSB pattern such that a slot (e.g., an SSB occasion) indicates one SSB instead of two SSBs. In such cases, the UE may replace repeated (e.g., duplicate) PSS or SSS symbols with empty symbols or with additional PBCH. In some examples, the network entity may transmit the additional PBCH in a second half of the SSB occasion such that the UE may receive the PBCH in cases where the UE has a low signal-to-noise ratio (SNR).

Aspects of the disclosure are initially described in the context of wireless communications systems. Aspects of the disclosure are additionally illustrated with reference to SSB patterns and process flows. Aspects of the disclosure are further illustrated by and described with reference to apparatus diagrams, system diagrams, and flowcharts that relate to SSB configuration for MTC devices.

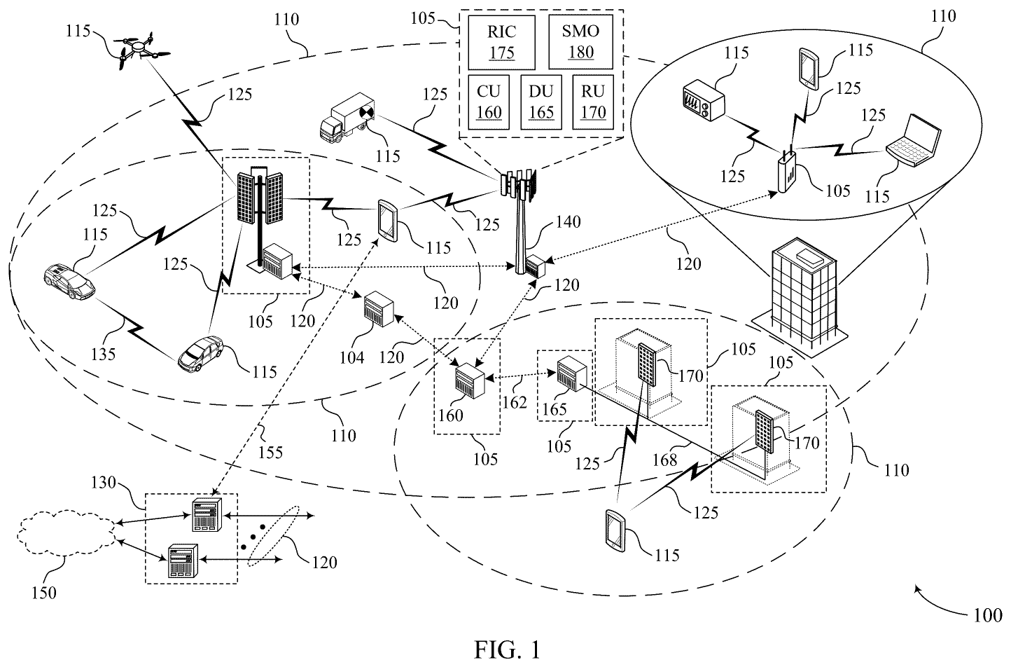

FIG. 1 shows an example of a wireless communications system 100 that supports SSB configuration for MTC devices in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a MTC device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing (SCS) may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, for which Δƒₘₐₓ may represent a supported SCS, and N_{ƒ} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on SCS. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{ƒ}) sampling periods. The duration of a symbol period may depend on the SCS or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some examples, a UE 115 may receive an SSB from a network entity 105. The UE may be an MTC UE associated with a reduced capability, including a reduced bandwidth. The network entity 105 may format the SSB such that the UE 115 may detect and receive the SSB in accordance with the reduced bandwidth of the UE 115. In some examples, the network entity 105 may transmit the SSB over 20 PRBs. The UE 115 may monitor a first quantity of PRBs that are above a synchronization raster point during a first SSB occasion (e.g., an even SSB occasion). Similarly, the UE 115 may monitor a second quantity of PRBs that are below the synchronization raster point during a second SSB occasion (e.g., an odd SSB occasion). In some examples, the first quantity of PRBs and the second quantity of PRBs may be based on the capability of the UE. For example, both the first quantity and the second quantity of PRBs may be 6 PRBs in accordance with the reduced bandwidth capability of the UE 115. To compensate for the reduced capability of the UE 115, the network entity 105 may duplicate and conjugate the PSS and the SSS such that the UE may receive the PSS and the SSS over two symbols each. The first quantity of PRBs and the second quantity of PRBs may each span a half of a symbol, and accordingly, may each include a half of the PSS or the SSS received during such a symbol. The UE 115 may monitor the first quantity of PRBs to receive a portion of the PSS and a portion of the conjugated PSS, which the UE 115 may combine to reconstruct a complete PSS. Similarly, the UE 115 may monitor the first quantity of PRBs to receive a portion of the SSS and a portion of the conjugated SSS, which the UE 115 may combine to reconstruct a complete SSS. After receiving the PSS and the SSS, the UE 115 may decode the SSB and perform cell acquisition with the network entity 105.

In some other examples, the network entity 105 may transmit the SSB over 6 PRBs. To compensate for the reduced capability of the UE 115, the network entity 105 may include the PSS and the SSS in multiple symbols. For example, the UE 115 may receive the PSS and the SSS over two symbols each, where a first symbol includes a first half (e.g., an upper half) of the PSS or the SSS, and where a second symbol includes a second half (e.g., a lower half) of the PSS or the SSS. In some cases, the network entity 105 may transmit SSS in two contiguous symbols of the SSB to minimize the effects of a phase difference between the two symbols including the SSS. Alternatively, the network entity 105 may format the SSB in accordance with a reduced density SSB pattern such that a slot (e.g., an SSB occasion) indicates one SSB instead of two SSBs. In such cases, the network entity 105 may replace repeated (e.g., duplicate) PSS or SSS symbols with empty symbols or with additional PBCH. In some examples, the network entity 105 may transmit the additional PBCH in a second half of the SSB occasion such that the UE 115 may receive the PBCH in cases where the UE 115 has a low SNR.

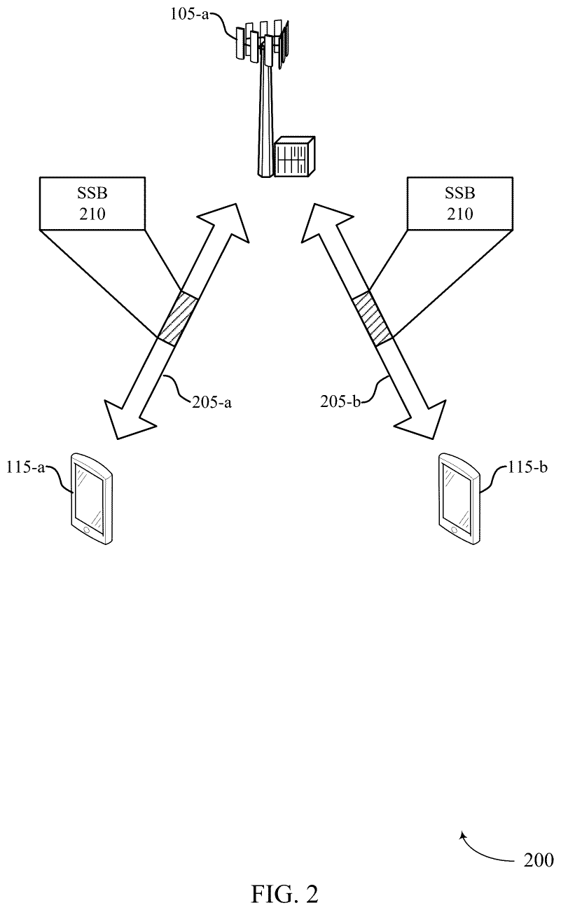

FIG. 2 shows an example of a wireless communications system 200 that supports SSB configuration for MTC devices in accordance with one or more aspects of the present disclosure. The wireless communications system 200 may include a first UE 115-a and a second UE 115-b in communications with a network entity 105-a, which may be examples of corresponding devices as described herein, including with reference to FIG. 1. The first UE 115-a may communicate with the network entity 105-a via a first communication link 205-a (e.g., via uplink, downlink, or both). The second UE 115-b may communicate with the network entity 105-b via a second communication link 205-b (e.g., via uplink, downlink, or both). In the example of FIG. 2, the wireless communications system 200 may be an example of a sixth generation (6G) system.

The first UE 115-a may have a first capability, and the second UE 115-b may have a second capability different from the first capability. In the example of FIG. 2, the first UE 115-a may be associated with a reduced capability relative to the second UE 115-b. For example, the first UE 115-a may be an example of an IoT device. In the example of FIG. 2, the first UE 115-a may be a MTC device, which may have a reduced capability relative to other IoT devices. For example, the first UE 115-a may support a reduced bandwidth for communications. In the example of FIG. 2, the first UE 115-a may support a baseband bandwidth of 1.08 MHz, which may span six physical resource blocks (PRBs) with a SCS of 15 kilohertz (kHz).

In some examples, as a part of a cell acquisition procedure, the network entity 105-a may transmit synchronization signaling to the first UE 115-a and the second UE 115-b. For example, the network entity 105-a may transmit a SSB 210 to the first UE 115-a and the second UE 115-b. The network entity 105-a may format the SSB 210 such that both the first UE 115-a and the second UE 115-b may receive the SSB 210. For example, if the first UE 115-a has reduced bandwidth capabilities such that the first UE 115-a supports a bandwidth of 1.08 MHZ (e.g., 6 PRBs with SCS of 15 kHz) and the second UE 115-b supports a bandwidth of 3 MHz (e.g., 12 PRBs with SCS of 15 kHz) or 5 MHz (e.g., 20 PRBs with SCS of 15 kHz), the network entity 105-a may format the SSB 210 such that at least a portion of the SSB 210 is transmitted within the bandwidth supported by the first UE 115-a (e.g., within 6 PRBs). The SSB 210 may be comprised of a PSS, an SSS, and a PBCH.

The SSB 210 may be associated with a synchronization raster point. The synchronization raster point may indicate frequency positions of the SSB 210 for the first UE 115-a, the second UE 115-b, or both, to use for cell acquisition. For example, the synchronization raster point may indicate a center frequency of the SSB 210. The network entity 105-a may configure the synchronization raster point. In some examples, the network entity 105-a may configure the synchronization raster point for the SSB 210 to be the same as the synchronization raster point for a NR SSB of 20 PRBs, a NR SSB of 12 PRBs, or a 6G SSB spanning a bandwidth greater than 6 PRBs. In such examples, the network entity 105-a may add additional symbols to the SSB 210 to assist the first UE 115-a in receiving and decoding the SSB 210. For example, the network entity 105-a may include a conjugated PSS, a conjugated SSS, additional conjugated PBCH symbols, or any combination thereof, to assist the first UE 115-a in receiving and decoding the SSB 210. The first UE 115-a may perform blind detection (e.g., of the conjugated PSS, the conjugated SSS, the conjugated PBCH) to receive the SSB 210 using the synchronization raster point. In some other examples, the network entity 105-a may configure a new synchronization raster point for the SSB 210. The new synchronization raster point may be specific to the first UE 115-a.

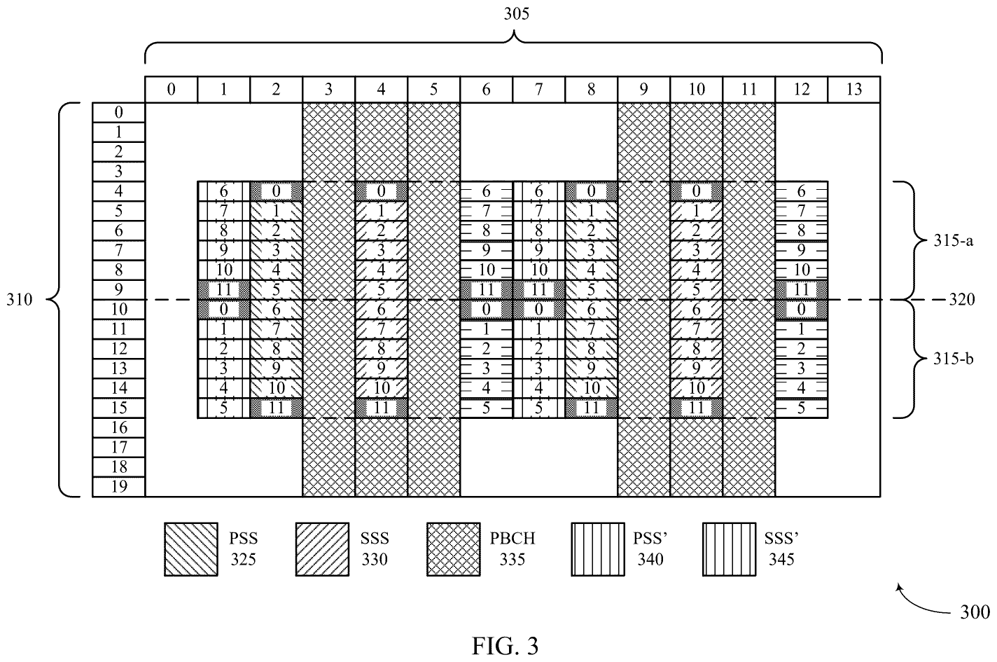

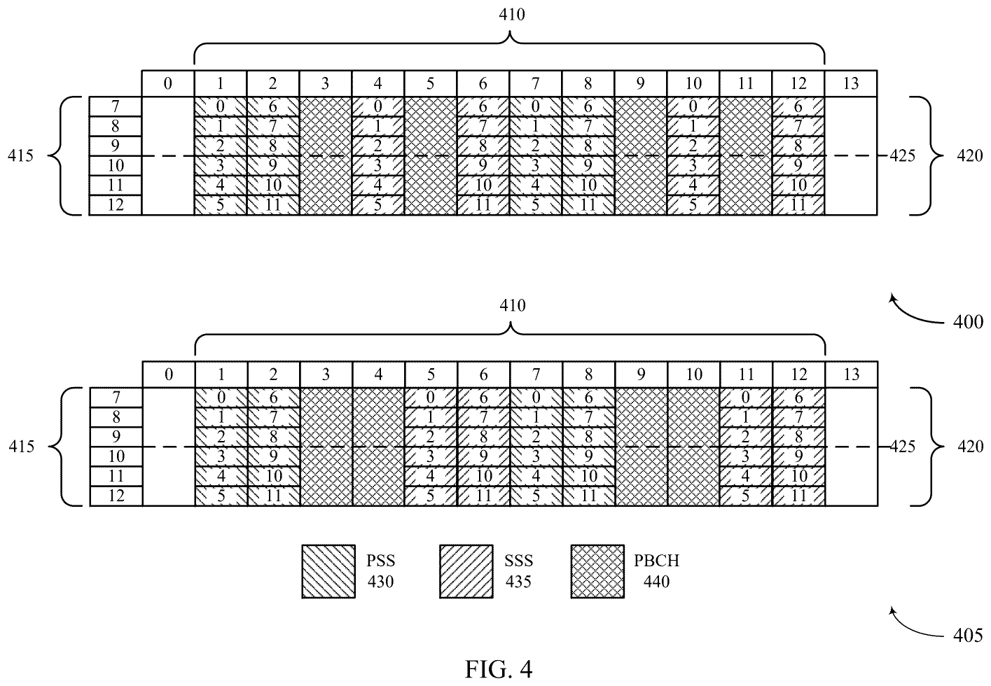

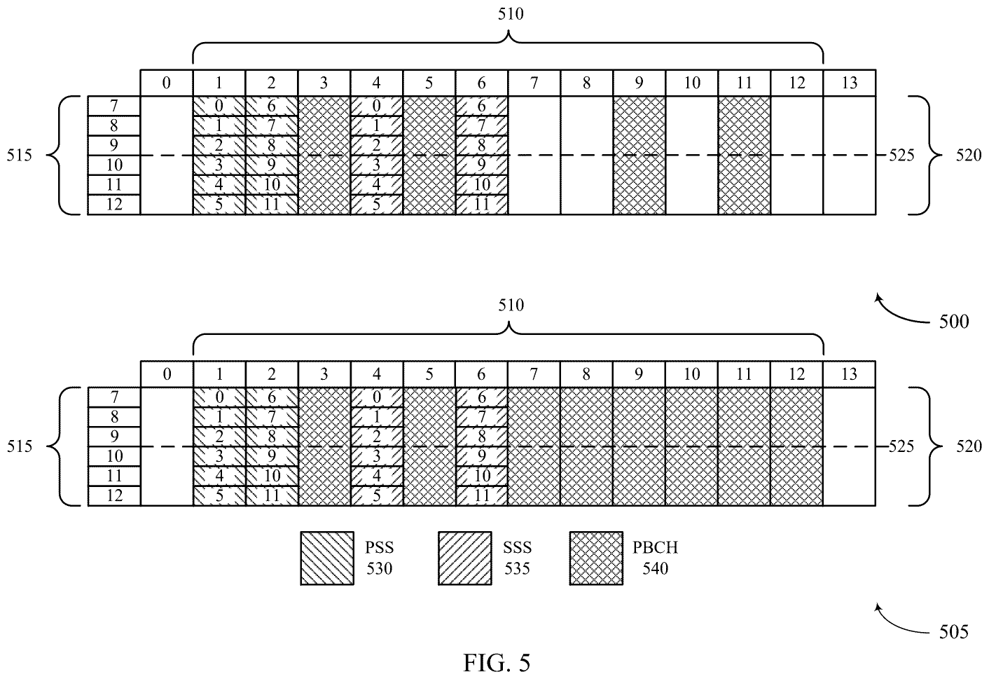

In some examples, the network entity 105-a may configure the SSB 210 by modifying an existing SSB format to include new information specific to the first UE 115-a, which may be described in further detail herein with reference to FIG. 3. In some other examples, the network entity 105-a may configure the SSB 210 in accordance with a new SSB format based on the capability of the first UE 115-a, which may be described in further detail herein with reference to FIGS. 4 and 5.

FIG. 3 shows an example of a SSB pattern 300 that supports SSB configuration for MTC devices in accordance with one or more aspects of the present disclosure. The SSB pattern 300 may be implemented by communications between a UE and a network entity, which may be examples of corresponding devices as described herein, including with reference to FIGS. 1 and 2. For example, the UE may be an example of an MTC UE, as described with reference to FIG. 2. The MTC UE may support a baseband bandwidth that is less than 3 MHz, may support a radio-frequency bandwidth that is less than 3 MHz, or both. The SSB pattern 300 may indicate time and frequency resources that are allocated for SSBs. For example, the SSB pattern 300 may be defined over a quantity of symbols 305 (e.g., time resources) and over a quantity of PRBs 310 (frequency resources). The network entity may transmit SSB in accordance with the SSB pattern 300.

In some examples, the network entity may transmit SSB via a bandwidth that exceeds (e.g., is larger than) the bandwidth capability of the MTC UE. For example, the network entity may transmit SSB that is configured for non-MTC UEs. In the example of FIG. 3, the network entity may transmit SSBs via 20 PRBs 310 with a SCS of 15 kHz, but the MTC UE may support a bandwidth of 6 PRBs 310 with a SCS of 15 kHz. Accordingly, to receive SSBs transmitted from the network entity, the MTC UE may monitor a first resource group 315-a (e.g., a first subset of resources, a first subset of PRBs 310) of the SSB during a first SSB occasion (e.g., an even SSB occasion). The first resource group 315-a may be associated with a capability of the MTC UE. For example, the MTC UE may monitor the first resource group 315-a in accordance with a bandwidth capability of the MTC UE. In some examples, the first resource group 315-a may occupy one or more frequency resources that are greater than a center frequency of a synchronization raster point 320 configured for SSB monitoring.

Similarly, the MTC UE may monitor a second resource group 315-b (e.g., a second subset of resources, a second subset of PRBs 310) of the SSB during a second SSB occasion (e.g., an odd SSB occasion). The second resource group 315-b may also be associated with the capability of the MTC UE. For example, the MTC UE may monitor the second resource group 315-b in accordance with the bandwidth capability of the MTC UE. In some examples, the second resource group 315-b may occupy one or more frequency resources that are less than the center frequency of the synchronization raster point 320 configured for SSB monitoring.

In some examples, a quantity of resources of the first resource group 315-a may be the same as a quantity of resources of the second resource group 315-b in accordance with the bandwidth capability of the MTC UE. In the example of FIG. 3, the MTC UE may support a bandwidth of 1.08 MHz and accordingly, may monitor 6 PRBs 310 corresponding to the first resource group 315-a and may monitor 6 PRBs 310 corresponding to the second resource group 315-b. In some examples, the first resource group 315-a may represent an upper half of the SSB pattern 300, and the second resource group 315-b may represent a lower half of the SSB pattern 300.

The SSB pattern 300 may indicate an SSB density of two SSBs per slot. Each SSB may be comprised of a PSS 325, an SSS 330, and one or more PBCH 335. In the example of FIG. 3, the network entity may transmit the PSS 325 during a first symbol 305 of each SSB (e.g., symbol 2, symbol 8), may transmit the SSS during a third symbol 305 of each SSB (e.g., symbol 5, symbol 10), and may transmit the PBCH 335 during a second symbol 305 of each SSB (e.g., symbol 3, symbol 9) and during a fourth symbol 305 of each SSB (e.g., symbol 5, symbol 11). In some examples where the network entity transmits SSB via a bandwidth that is greater than the bandwidth capability of the MTC UE, the components of each SSB may also be transmitted via bandwidths that are greater than the bandwidth capability of the MTC UE.

In the example of FIG. 3, the PSS 325 and the SSS 330 may be transmitted via 12 PRBs 310, and the PBCH 335 may be transmitted via 20 PRBs 310, both of which may exceed the 6 PRB bandwidth supported by the MTC UE. In some examples, the first resource group 315-a may include a first half (e.g., an upper half) of the PSS 325 and the SSS 330. Similarly, the second resource group 315-b may include a second half (e.g., a lower half) of the PSS 325 and the SSS 330. The first half of the PSS 325 and the SSS 330 may not be the same as the second half of the PSS 325 and the SSS 330. That is, each resource group 315 may include a different portion of the PSS 325 and the SSS 330. Accordingly, the MTC UE may be unable to receive and decode the PSS 325, the SSS 330, and the PBCH 335.

The SSB pattern 300 may be based on existing SSB formats for NR communications such that non-MTC UEs may receive SSB from the network entity. However, the SSB pattern 300 may include signaling in four additional symbols 305 such that MTC UEs may be able to receive and decode SSB from the network entity. For example, to compensate for the reduced bandwidth capability of the MTC UE, the network entity may include additional synchronization information before and after the SSB to assist the MTC UE in detecting the PSS 325 and the SSS 330. In some examples, the MTC UE may receive a PSS' 340 (e.g., a conjugated PSS 325) during a symbol 305 preceding the SSB (e.g., symbol 1, symbol 7) and may receive a SSS' (e.g., a conjugated SSS 330) during a symbol 305 following the SSB (symbol 6, symbol 12). The PSS' 340 and the SSS' 345 may be based on a different resource element mapping compared to the PSS 325 and the SSS 330, respectively, to avoid false detection by non-MTC UEs. In some examples, the PSS' 340 and the SSS' 345 may be formatted such that the first half and the second half of the PSS 325 and the first half and the second half of the SSS 330 are switched. For example, a first half of the PSS' 340 may correspond to the second half of the PSS 325, and a first half of the SSS' 345 may correspond to the second half of the SSS 330. Similarly, a second half of the PSS' 340 may correspond to the first half of the PSS 325, and a second half of the SSS' 345 may correspond to the first half of the SSS 330.

By receiving both the PSS 325 and the PSS' 340, and by receiving both the SSS 330 and the SSS' 345, the MTC UE may be able to receive the PSS 325 and the SSS 330 within the bandwidth capability of the MTC UE. For example, the MTC UE may monitor the first resource group 315-a during a first SSB occasion to receive a first portion (e.g., the first half) of the PSS' 340 and a first portion (e.g., the first half) of the PSS 325. The combination of the first portion of the PSS' 340 and the first portion of the PSS 325 may comprise the complete PSS 325. The MTC UE may also monitor the first resource group 315-a during the first SSB occasion to receive a first portion (e.g., the first half) of the SSS' 345 and a first portion (e.g., the first half) of the SSS 330. The combination of the first portion of the SSS' 345 and the first portion of the SSS 330 may comprise the complete SSS 330.

Similarly, the MTC UE may monitor the second resource group 315-b during a second SSB occasion to receive a second portion (e.g., the second half) of the PSS' 340 and a second portion (e.g., the second half) of the PSS 325. The combination of the second portion of the PSS' 340 and the second portion of the PSS 325 may comprise the complete PSS 325. The MTC UE may also monitor the second resource group 315-b during the second SSB occasion to receive a second portion (e.g., the second half) of the SSS' 345 and a second portion (e.g., the second half) of the SSS 330. The combination of the second portion of the SSS' 345 and the second portion of the SSS 330 may comprise the complete SSS 330.

In some examples, the MTC UE may be associated with a low SNR. In such examples, to receive the PBCH 335, the MTC UE may combine PBCHs 335 received during even SSB occasions and during odd SSB occasions. For example, the MTC UE may receive a first portion of the PBCH 335 during an even SSB occasion and may receive a second portion of the PBCH 335 during an odd SSB occasion. Alternatively, the network entity may transmit multiple SSB each with a different index via a same transmission beam. The MTC UE may combine SSBs with different indices to receive the PBCH 335.

FIG. 4 shows an example of a SSB pattern 400 and an SSB pattern 405 that support SSB configuration for MTC devices in accordance with one or more aspects of the present disclosure. The SSB pattern 400 and the SSB pattern 405 may be implemented by communications between a UE and a network entity, which may be examples of corresponding devices as described herein, including with reference to FIGS. 1 and 2. For example, the UE may be an example of an MTC UE, as described with reference to FIG. 2. The MTC UE may support a baseband bandwidth that is less than 3 MHz, may support a radio-frequency bandwidth that is less than 3 MHz, or both. The SSB pattern 400 and the SSB pattern 405 may indicate time and frequency resources that are allocated for SSBs. For example, the SSB pattern 400 and the SSB pattern 405 may be defined over a quantity of symbols 410 (e.g., time resources) and over a quantity of PRBs 415 (frequency resources). The network entity may transmit SSB in accordance with the SSB pattern 400, with the SSB pattern 405, or both.

In some examples, the MTC UE may receive SSB via a bandwidth that is within the bandwidth capability of the MTC UE. For example, the network entity may transmit SSB that is configured for both MTC UEs and non-MTC UEs. In the example of FIG. 3, the MTC UE may support a bandwidth of 6 PRBs 415 with a SCS of 15 kHz, and the network entity may transmit SSBs via 6 PRBs 415 with a SCS of 15 kHz. Accordingly, to receive SSBs transmitted from the network entity, the MTC UE may monitor a resource group 420 (e.g., PRBs 415) of the SSB during each SSB occasion (e.g., even SSB occasions, odd SSB occasions). The resource group 420 may be associated with a capability of the MTC UE. For example, the MTC UE may monitor the resource group 420 in accordance with a bandwidth capability of the MTC UE. Detection performance of the MTC UE for receiving SSB in accordance with the SSB pattern 400 or the SSB pattern 405 may be similar to detection performance of a non-MTC UE for receiving a SSB formatted for NR communications (e.g., a SSB over a 3 MHz channel bandwidth, a SSB over 12 PRBs).

In some examples, a quantity of resources of the resource group 420 may be the same as the bandwidth capability of the MTC UE. In the example of FIG. 4, the MTC UE may support a bandwidth of 1.08 MHz and accordingly, may monitor 6 PRBs 415 corresponding to the resource group 420. A location of the resource group 420 (e.g., in frequency) may be based on a synchronization raster point 425, which may be configured by the network entity. For example, the resource group 420 may be centered along the synchronization raster point 425 such that a first half (e.g., an upper half) of the resource group 420 is above the synchronization raster point 425 (e.g., in frequency) and that a second half (e.g., a lower half) of the resource group 420 is below the synchronization raster point 425 (e.g., in frequency).

The SSB pattern 400 and the SSB pattern 405 may indicate an SSB density of two SSBs per slot. Each SSB may be comprised of a PSS 430, an SSS 435, and one or more PBCH 440. The PSS 430 and the SSS 435 may be formatted differently from similar synchronization signals defined for NR communications to avoid false detection by non-MTC UEs. In the example of FIG. 4, the MTC UE may receive each of the PSS 430, the SSS 435, and the PBCH 440 via two symbols 410. The two symbols 410 used to receive the PSS 430 may be contiguous (e.g., consecutive) symbols. For example, in accordance with the SSB pattern 400, the SSB pattern 405, or both, the MTC UE may receive the PSS 430 during a first two symbols 410 of each SSB (e.g., symbols 1 and 2, symbols 7 and 8).

In some examples, the two symbols 410 used to receive the SSS 435 and the two symbols 410 used to transmit the PBCH 440 may be non-contiguous. For example, in accordance with the SSB pattern 400, the MTC UE may receive the PBCH 440 during a third symbol 410 and a fifth symbol 410 of each SSB (e.g., symbols 3 and 5, symbols 9 and 11). Similarly, the MTC UE may receive the SSS 435 during a fourth symbol 410 and a sixth symbol 410 of each SSB (e.g., symbols 4 and 6, symbols 10 and 12).

In some other examples, the two symbols 410 used to receive the SSS 435 may be contiguous. The MTC UE may receive the SSS 435 via contiguous symbols to reduce the effects of a phase difference across the two symbols 410 used to receive the SSS 435. For example, the MTC UE may receive the SSS 435 during two contiguous symbols 410 following the PSS 430. In accordance with the SSB pattern 405, the MTC UE may receive the SSS 435 during a final two symbols 410 of each SSB (e.g., symbols 5 and 6, symbols 11 and 12). In such examples, the MTC UE may also receive the PBCH 440 in two consecutive symbols 410. For example, in accordance with the SSB pattern 405, the MTC UE may receive the PBCH during two symbols 410 consecutive to the PSS 430 (e.g., symbols 3 and 4, symbols 9 and 10). Alternatively, the MTC UE may receive the SSS 435 during the two symbols 410 consecutive to the PSS 430 (e.g., symbols 3 and 4, symbols 9 and 10) and may receive the PBCH 440 during the final two symbols 410 of each SSB (e.g., symbols 5 and 6, symbols 11 and 12).

Alternatively, the two symbols 410 used to receive the SSS 435 may be contiguous, but the two symbols 410 used to receive the PBCH 440 may be non-contiguous. For example, the MTC UE may receive the PBCH 440 during a third symbol 410 and a sixth symbol 410 of each SSB (e.g., symbols 3 and 6, symbols 9 and 12). The MTC UE may receive the SSS 435 during a fourth symbol 410 and a fifth symbol 410 of each SSB (e.g., symbols 4 and 5, symbols 10 and 11).

In some examples where the MTC UE receives SSB via a bandwidth that is within the bandwidth capability of the MTC UE, the components of the SSB may also be received via bandwidths that are within the bandwidth capability of the MTC UE. In the example of FIG. 4, the PSS 430, the SSS 435, and the PBCH 440 may be received via 6 PRBs 415, both of which may be within the 6 PRB bandwidth supported by the MTC UE. In some examples where the PSS 430, the SSS 435, and the PBCH 440 are each received via two symbols 410, each individual symbol 410 may include a portion of the PSS 430, the SSS 435, or the PBCH 440. For example, a first symbol 410 of a PSS 430 may include a first half (e.g., an upper half) of the PSS 430, and a second symbol 410 of the PSS 430 may include a second half (e.g., a lower half) of the PSS 430. The SSS 435 and the PBCH 440 may be similarly divided between symbols 410.

In some examples, the MTC UE may be associated with a low SNR. In such examples, to receive the PBCH 440, the MTC UE may combine PBCHs 440 received during even SSB occasions and during odd SSB occasions. For example, the MTC UE may receive a first portion of the PBCH 440 during an even SSB occasion and may receive a second portion of the PBCH 440 during an odd SSB occasion. Alternatively, the network entity may transmit multiple SSB each with a different index via a same transmission beam. The MTC UE may combine SSBs with different indices to receive the PBCH 440.

FIG. 5 shows an example of a SSB pattern 500 and a SSB pattern 505 that support SSB configuration for MTC devices in accordance with one or more aspects of the present disclosure. The SSB pattern 500 and the SSB pattern 505 may be implemented by communications between a UE and a network entity, which may be examples of corresponding devices as described herein, including with reference to FIGS. 1 and 2. For example, the UE may be an example of an MTC UE, as described with reference to FIG. 2. The MTC UE may support a baseband bandwidth that is less than 3 MHZ, may support a radio-frequency bandwidth that is less than 3 MHZ, or both. The SSB pattern 500 and the SSB pattern 505 may indicate time and frequency resources that are allocated for SSBs. For example, the SSB pattern 500 and the SSB pattern 505 may be defined over a quantity of symbols 510 (e.g., time resources) and over a quantity of PRBs 515 (frequency resources). The network entity may transmit SSB in accordance with the SSB pattern 500, with the SSB pattern 505, or both.

In some examples, the MTC UE may receive SSB via a bandwidth that is within the bandwidth capability of the MTC UE. For example, the MTC UE may receive SSB that is configured for both MTC UEs and non-MTC UEs. In the example of FIG. 3, the MTC UE may support a bandwidth of 6 PRBs 515 with a SCS of 15 kHz, and the network entity may transmit SSBs via 6 PRBs 515 with a SCS of 15 kHz. Accordingly, to receive SSBs transmitted from the network entity, the MTC UE may monitor a resource group 520 (e.g., PRBs 515) of the SSB during each SSB occasion (e.g., even SSB occasions, odd SSB occasions). The resource group 520 may be associated with a capability of the MTC UE. For example, the MTC UE may monitor the resource group 520 in accordance with a bandwidth capability of the MTC UE. Detection performance of the MTC UE for receiving SSB in accordance with the SSB pattern 500 or the SSB pattern 505 may be similar to detection performance of a non-MTC UE for receiving a SSB formatted for NR communications (e.g., a SSB over a 3 MHz channel bandwidth, a SSB over 12 PRBs).

In some examples, a quantity of resources of the resource group 520 may be the same as the bandwidth capability of the MTC UE. In the example of FIG. 5, the MTC UE may support a bandwidth of 1.08 MHz and accordingly, may monitor 6 PRBs 515 corresponding to the resource group 520. A location of the resource group 520 (e.g., in frequency) may be based on a synchronization raster point 525, which may be configured by the network entity. For example, the resource group 520 may be centered along the synchronization raster point 525 such that a first half (e.g., an upper half) of the resource group 520 is above the synchronization raster point 525 (e.g., in frequency) and that a second half (e.g., a lower half) of the resource group 520 is below the synchronization raster point 525 (e.g., in frequency).

The SSB pattern 500 and the SSB pattern 505 may indicate an SSB density of one SSB per slot, which may be less dense relative to an NR SSB pattern. The SSB may be comprised of a PSS 530, an SSS 535, and one or more PBCH 540. The PSS 530 and the SSS 535 may be formatted differently from similar synchronization signals defined for NR communications to avoid false detection by non-MTC UEs. In the example of FIG. 5, the MTC UE may receive each of the PSS 530 and the SSS 535 via two symbols 510. The two symbols 510 used to receive the PSS 530 may be contiguous, and the two symbols 510 used to receive the SSS 535 may be non-contiguous. For example, in accordance with the SSB pattern 500, the SSB pattern 505, or both, the MTC UE may receive the PSS 430 during a first two symbols 510 of the SSB (e.g., symbols 1 and 2) and may receive the SSS 535 during a fourth symbol 510 and a sixth symbol 510 of the SSB (e.g., symbols 4 and 6).

In some examples, the MTC UE may receive the PBCH 540 via four symbols 510. For example, in accordance with the SSB pattern 500, the MTC UE may receive the PBCH during a third symbol 510, a fifth symbol 510, a ninth symbol 510, and an eleventh symbol 510 of the SSB (e.g., symbols 3, 5, 9, and 11). In such examples, the network entity may refrain from transmitting second instances of the PSS 530 and the SSS 535 corresponding to a second SSB. For example, the network entity may not transmit PSS 530 during symbols 7 and 8 and may not transmit SSS 535 during symbols 10 and 12. In accordance with the SSB pattern 500, symbols 7, 8, 10, and 12 may be empty. The four symbols 510 for receiving the PBCH 540 may be non-contiguous within an SSB occasion. For example, the MTC UE may not receive PSS 530 during symbols 7 and 8 and may not receive SSS 535 during symbols 10 and 12. In accordance with the SSB pattern 500, symbols 7, 8, 10, and 12 may be empty, and at least a portion of the symbols 510 of the PBCH 540 (e.g., symbols 9 and 11) may be separated by the empty symbols 510.

In some other examples, the MTC UE may receive the PBCH 540 via eight symbols 510. A first portion of the eight symbols 510 for receiving the PBCH 540 may be non-contiguous, and a second portion of the eight symbols 510 for receiving the PBCH 540 may be contiguous. The first portion of the eight symbols 510 (e.g., a first portion of the PBCH 540) may be received during a first half of the SSB occasion represented by the SSB pattern 505. For example, in accordance with the SSB pattern 505, the MTC UE may receive the first portion of the PBCH 540 during a third symbol 510 and a fifth symbol 510 of the SSB (e.g., symbols 3, 5). The second portion of the eight symbols 510 (e.g., a second portion of the PBCH 540) may be received during a second half of the SSB occasion represented by the SSB pattern 505. For example, the MTC UE may receive the second portion of the PBCH 540 during six contiguous symbols 510 comprising the second half of the SSB occasion (e.g., symbols 7-12). In such examples, the network entity may transmit the PBCH 540 during the empty symbols 510 to transmit additional (e.g., remaining) PBCH 540 and improve decoding of the PBCH 540 at the UE for low SNR.

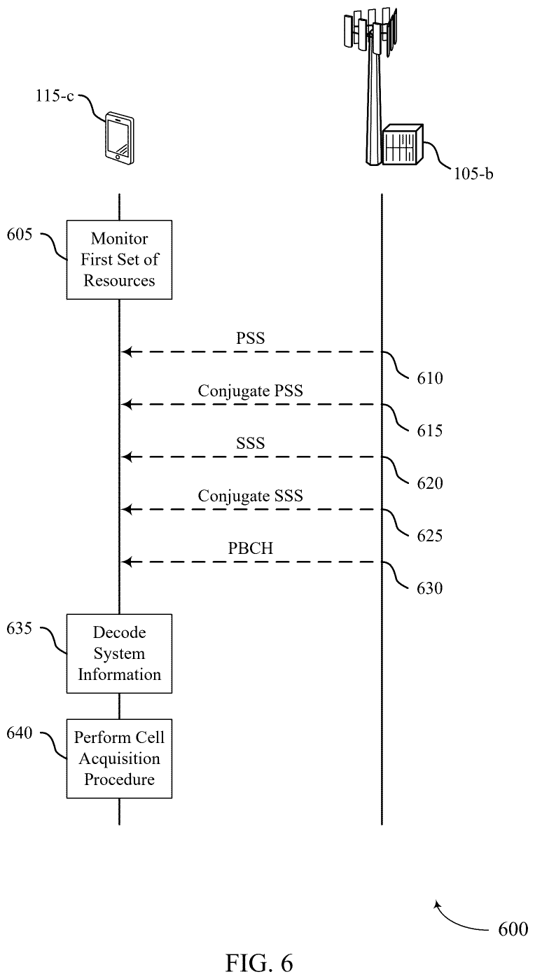

FIG. 6 shows an example of a process flow 600 that supports SSB configuration for MTC devices in accordance with one or more aspects of the present disclosure. The process flow 600 may implement or be implemented by aspects of the wireless communications system 100 and the wireless communications system 200, as described with reference to FIGS. 1 and 2. For example, the process flow 600 illustrates actions performed by a UE 115-c and a network entity 105-b, which may be examples of corresponding devices described herein, including with reference to FIGS. 1-2. In the following description of the process flow 600, the operations between the UE 115-c and the network entity 105-b may be performed in a different order than the example shown, or the operations between the UE 115-c and the network entity 105-b may be performed in different orders at different times. Some operations may also be omitted from the process flow 600, and other operations may be added to the process flow 600. In the example of FIG. 6, the UE 115-c may be a MTC UE.

At 605, the UE 115-c may monitor a first set of resources for a SSB based on a capability of the UE 115-c. The first set of resources may be different from a second set of resources allocated for one or more wireless devices having a different capability than the capability of the UE 115-c. In some examples, the UE 115-c may monitor six resource blocks at a SCS of 15 kHz for the SSB based on the capability of the UE 115-c. The UE 115-c may monitor the first set of resources in accordance with a synchronization raster point of the SSB. In some examples, the synchronization raster point may be based on a bandwidth associated with the SSB, may be based on a capability of the UE 115-c, or both.

To monitor the first set of resources, the UE 115-c may monitor a first subset of resources corresponding to a first SSB occasion. In some examples, the first subset of resources may span one or more resource blocks associated with frequencies greater than a center frequency of a synchronization raster point for SSB monitoring. A quantity of the first subset of resources may be based on the capability of the UE 115-c. Additionally, the UE 115-c may monitor a second subset of resources corresponding to a second SSB occasion. In such examples, the second subset of resources may span one or more resource blocks associated with frequencies less than the center frequency of the synchronization raster point for SSB monitoring. A quantity of the second subset of resources may be based on the capability of the UE 115-c.

At 610, the UE 115-c may receive a PSS. In some examples, the UE 115-c may receive a portion of the PSS based on monitoring the first set of resources. In some other examples, the UE 115-c may receive the PSS (e.g., a complete PSS) via a first plurality of contiguous symbols of the SSB. The UE 115-c may receive the PSS from the network entity 105-b.

At 615, the UE 115-c may receive a conjugate PSS. In some examples, the UE 115-c may receive a portion of the conjugate PSS based on monitoring the first set of resources. The portion of the PSS and the portion of the conjugate PSS may include the complete PSS (e.g., when combined). The UE 115-c may receive the conjugate PSS from the network entity 105-b.

At 620, the UE 115-c may receive an SSS. In some examples, the UE 115-c may receive a portion of the SSS based on monitoring the first set of resources. In some other examples, the UE 115-c may receive the SSS (e.g., a complete SSS) via a first plurality of non-contiguous symbols of the SSB. Alternatively, the UE 115-c may receive the SSS (e.g., the complete SSS) via a second plurality of contiguous symbols of the SSB. In such cases, the first plurality of contiguous symbols associated with receiving the PSS may be different from the second plurality of contiguous symbols. The UE 115-c may receive the SSS from the network entity 105-b.

At 625, the UE 115-c may receive a conjugate SSS. In some examples, the UE 115-c may receive a portion of the conjugate SSS based on monitoring the first set of resources. The portion of the SSS and the portion of the conjugate SSS may include the complete SSS (e.g., when combined). The UE 115-c may receive the conjugate SSS from the network entity 105-b.

At 630, the UE 115-c may receive a PBCH. In some examples, the UE 115-c may receive the PBCH via a plurality of non-contiguous symbols of the SSB. In some cases, the UE 115-c may receive the PBCH via a second plurality of non-contiguous symbols of the SSB that are different from the first plurality of non-contiguous symbols. In some other examples, the UE 115-c may receive the PBCH via a third plurality of contiguous symbols of the SSB. In such cases, the first plurality of contiguous symbols, the second plurality of contiguous symbols, and the third plurality of contiguous symbols may be different. The UE 115-c may receive the PBCH from the network entity 105-b.

In some examples where the UE 115-c receives the PBCH via a plurality of non-contiguous symbols of the SSB, at least a portion of the plurality of non-contiguous symbols may be separated within an SSB occasion of the SSB by one or more empty symbols. In some other examples, the UE 115-c may receive the PBCH via both a plurality of non-contiguous symbols of the SSB and a plurality of contiguous symbols of the SSB. In such cases, the plurality of contiguous symbols may occupy a half of an SSB occasion of the SSB in time.

At 635, the UE 115-c may decode system information associated with the SSB in accordance with the first set of resources. For example, the UE 115-c may decode the PSS, the SSS, and the PBCH received based on monitoring the first set of resources.

At 640, the UE 115-c may perform a cell acquisition procedure based at least in part on the system information. For example, the UE 115-c may perform a cell acquisition procedure with the network entity 105-b based on decoding the system information including the PSS, the SSS, and the PBCH of the SSB.

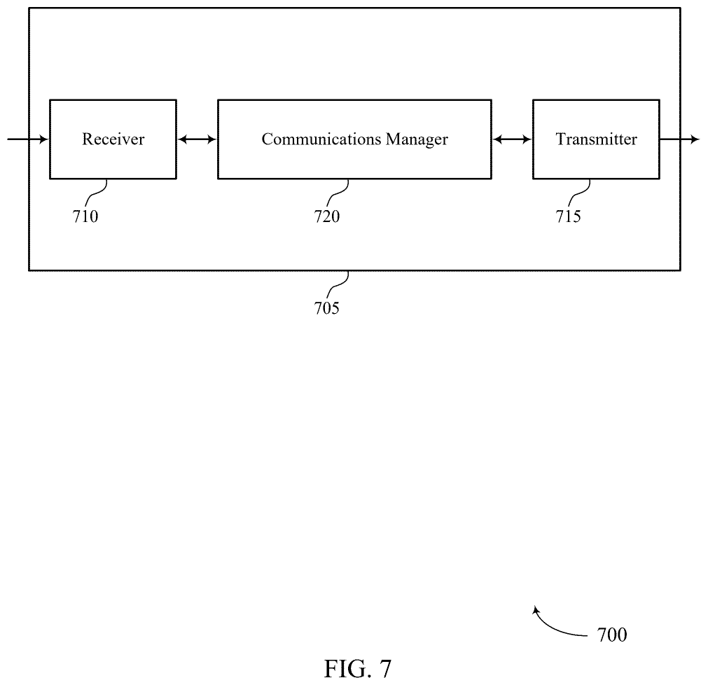

FIG. 7 shows a block diagram 700 of a device 705 that supports SSB configuration for MTC devices in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to SSB configuration for MTC devices). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to SSB configuration for MTC devices). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of SSB configuration for MTC devices as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for monitoring a first set of resources for a SSB based on a capability of the UE, where the first set of resources is different from a second set of resources allocated for one or more wireless devices having a different capability than the capability of the UE. The communications manager 720 is capable of, configured to, or operable to support a means for decoding system information associated with the SSB in accordance with the first set of resources. The communications manager 720 is capable of, configured to, or operable to support a means for performing a cell acquisition procedure based on the system information.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for more efficient utilization of communication resources.

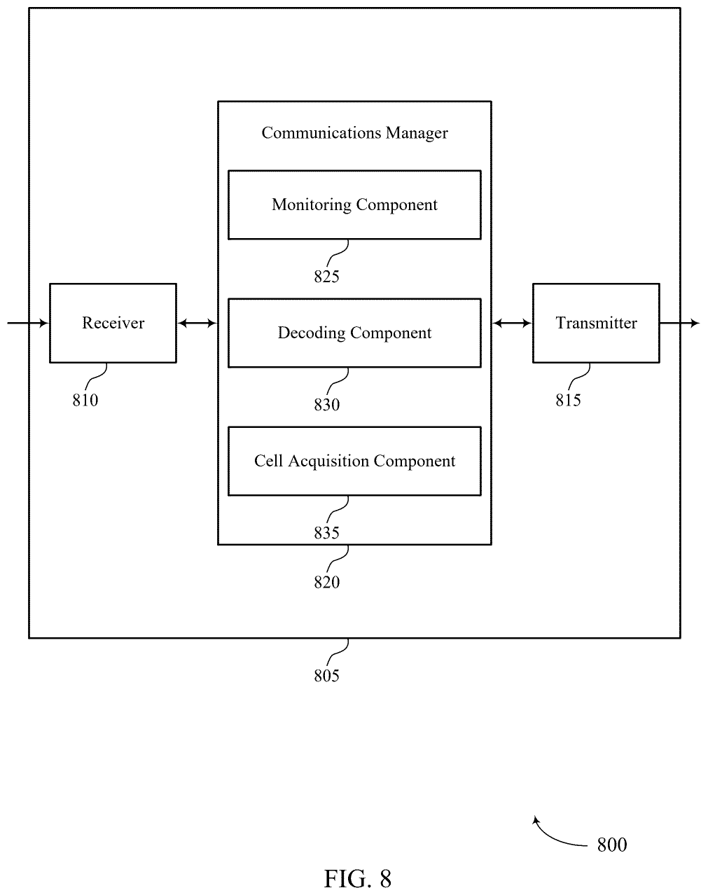

FIG. 8 shows a block diagram 800 of a device 805 that supports SSB configuration for MTC devices in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to SSB configuration for MTC devices). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to SSB configuration for MTC devices). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of SSB configuration for MTC devices as described herein. For example, the communications manager 820 may include a monitoring component 825, a decoding component 830, a cell acquisition component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The monitoring component 825 is capable of, configured to, or operable to support a means for monitoring a first set of resources for a SSB based on a capability of the UE, where the first set of resources is different from a second set of resources allocated for one or more wireless devices having a different capability than the capability of the UE. The decoding component 830 is capable of, configured to, or operable to support a means for decoding system information associated with the SSB in accordance with the first set of resources. The cell acquisition component 835 is capable of, configured to, or operable to support a means for performing a cell acquisition procedure based on the system information.

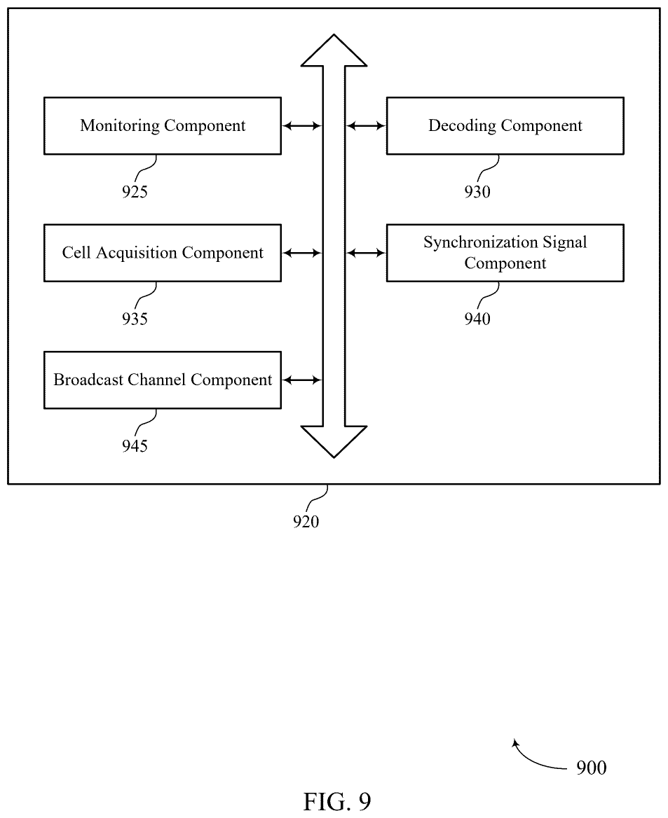

FIG. 9 shows a block diagram 900 of a communications manager 920 that supports SSB configuration for MTC devices in accordance with one or more aspects of the present disclosure. The communications manager 920 may be an example of aspects of a communications manager 720, a communications manager 820, or both, as described herein. The communications manager 920, or various components thereof, may be an example of means for performing various aspects of SSB configuration for MTC devices as described herein. For example, the communications manager 920 may include a monitoring component 925, a decoding component 930, a cell acquisition component 935, a synchronization signal component 940, a broadcast channel component 945, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The monitoring component 925 is capable of, configured to, or operable to support a means for monitoring a first set of resources for a SSB based on a capability of the UE, where the first set of resources is different from a second set of resources allocated for one or more wireless devices having a different capability than the capability of the UE. The decoding component 930 is capable of, configured to, or operable to support a means for decoding system information associated with the SSB in accordance with the first set of resources. The cell acquisition component 935 is capable of, configured to, or operable to support a means for performing a cell acquisition procedure based on the system information.

In some examples, to support monitoring the first set of resources for the SSB, the monitoring component 925 is capable of, configured to, or operable to support a means for monitoring a first subset of resources corresponding to a first SSB occasion, the first subset of resources spanning one or more resource blocks associated with frequencies greater than a center frequency of a synchronization raster point for SSB monitoring, where a quantity of the first subset of resources is based on the capability of the UE. In some examples, to support monitoring the first set of resources for the SSB, the monitoring component 925 is capable of, configured to, or operable to support a means for monitoring a second subset of resources corresponding to a second SSB occasion, the second subset of resources spanning one or more resource blocks associated with frequencies less than the center frequency of the synchronization raster point for SSB monitoring, where a quantity of the second subset of resources is based on the capability of the UE.

In some examples, the synchronization signal component 940 is capable of, configured to, or operable to support a means for receiving a portion of an PSS, a portion of a conjugate PSS, a portion of an SSS, and a portion of a conjugate SSS based on the monitoring, where the portion of the PSS and the portion of the conjugate PSS include a complete PSS, and where the portion of the SSS and the portion of the conjugate SSS include a complete SSS.

In some examples, the synchronization signal component 940 is capable of, configured to, or operable to support a means for receiving an PSS via a set of multiple contiguous symbols of the SSB. In some examples, the synchronization signal component 940 is capable of, configured to, or operable to support a means for receiving an SSS via a first set of multiple non-contiguous symbols of the SSB. In some examples, the synchronization signal component 940 is capable of, configured to, or operable to support a means for receiving a PBCH via a second set of multiple non-contiguous symbols of the SSB different from the first set of multiple non-contiguous symbols.

In some examples, the synchronization signal component 940 is capable of, configured to, or operable to support a means for receiving an PSS via a first set of multiple contiguous symbols of the SSB. In some examples, the synchronization signal component 940 is capable of, configured to, or operable to support a means for receiving an SSS via a second set of multiple contiguous symbols of the SSB. In some examples, the broadcast channel component 945 is capable of, configured to, or operable to support a means for receiving a PBCH via a third set of multiple contiguous symbols of the SSB, where the first set of multiple contiguous symbols, the second set of multiple contiguous symbols, and the third set of multiple contiguous symbols are different.

In some examples, the synchronization signal component 940 is capable of, configured to, or operable to support a means for receiving an PSS via a first set of multiple contiguous symbols of the SSB. In some examples, the synchronization signal component 940 is capable of, configured to, or operable to support a means for receiving an SSS via a second set of multiple contiguous symbols of the SSB. In some examples, the broadcast channel component 945 is capable of, configured to, or operable to support a means for receiving a PBCH via a set of multiple non-contiguous symbols of the SSB, where the first set of multiple contiguous symbols is different from the second set of multiple contiguous symbols.

In some examples, the broadcast channel component 945 is capable of, configured to, or operable to support a means for receiving a PBCH via a set of multiple non-contiguous symbols of the SSB, where at least a portion of the set of multiple non-contiguous symbols are separated within an SSB occasion of the SSB by one or more empty symbols.

In some examples, the broadcast channel component 945 is capable of, configured to, or operable to support a means for receiving a PBCH via a set of multiple non-contiguous symbols of the SSB and a set of multiple contiguous symbols of the SSB, where the set of multiple contiguous symbols occupies a half of an SSB occasion of the SSB in time.

In some examples, to support monitoring the first set of resources, the monitoring component 925 is capable of, configured to, or operable to support a means for monitoring six resource blocks at a SCS of 15 kHz for the SSB based on the capability of the UE.

In some examples, a synchronization raster point of the SSB is based on a bandwidth associated with the SSB.

In some examples, a synchronization raster point of the SSB is based on the capability of the UE.

In some examples, the UE is an MTC UE.

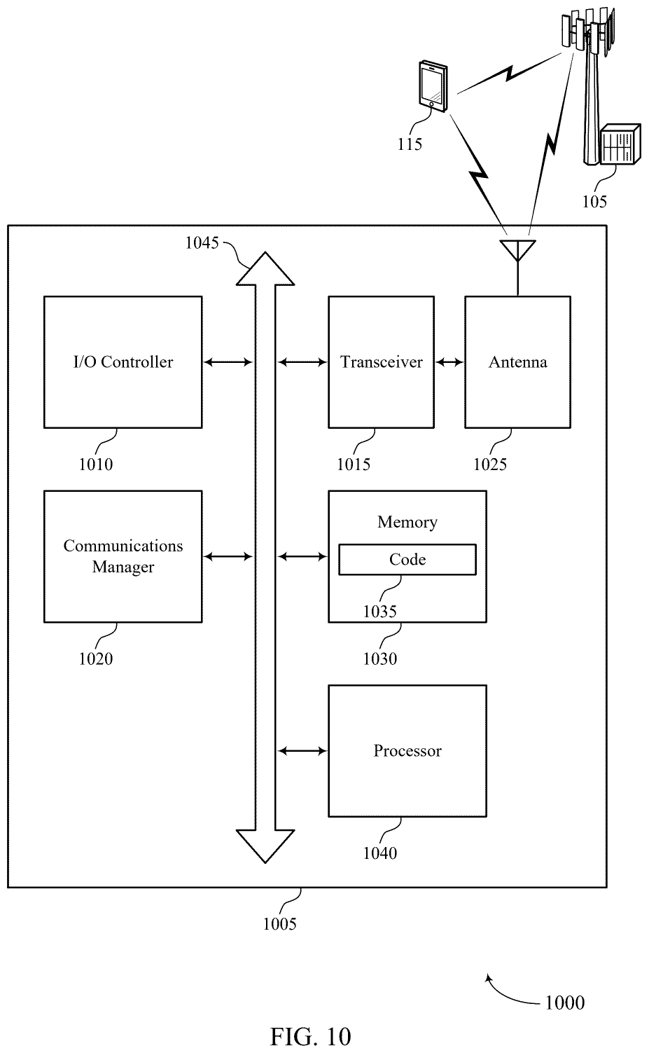

FIG. 10 shows a diagram of a system 1000 including a device 1005 that supports SSB configuration for MTC devices in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting SSB configuration for MTC devices). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for monitoring a first set of resources for a SSB based on a capability of the UE, where the first set of resources is different from a second set of resources allocated for one or more wireless devices having a different capability than the capability of the UE. The communications manager 1020 is capable of, configured to, or operable to support a means for decoding system information associated with the SSB in accordance with the first set of resources. The communications manager 1020 is capable of, configured to, or operable to support a means for performing a cell acquisition procedure based on the system information.

By including or configuring the communications manager 1020 in accordance with examples as described herein, the device 1005 may support techniques for improved communication reliability, reduced latency, and improved user experience related to more efficient utilization of communication resources and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of SSB configuration for MTC devices as described herein, or the at least one processor 1040 and the at least one memory 1030 may be otherwise configured to, individually or collectively, perform or support such operations.

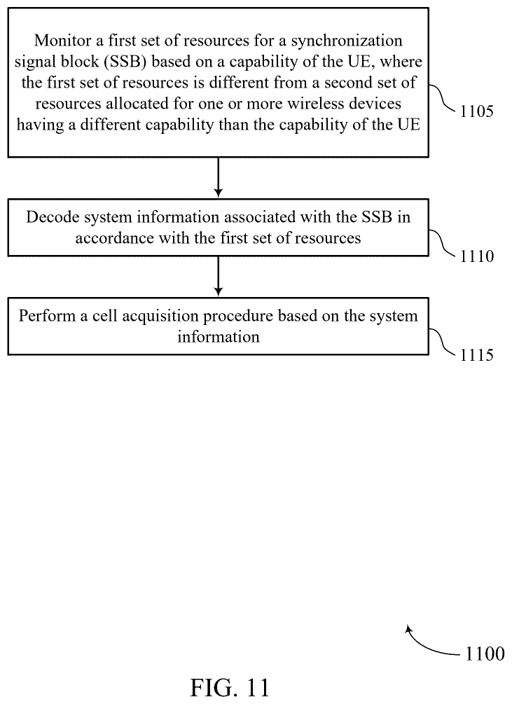

FIG. 11 shows a flowchart illustrating a method 1100 that supports SSB configuration for MTC devices in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include monitoring a first set of resources for a SSB based on a capability of the UE, where the first set of resources is different from a second set of resources allocated for one or more wireless devices having a different capability than the capability of the UE. The operations of 1105 may be performed in accordance with examples as disclosed herein. In some examples, aspects of the operations of 1105 may be performed by a monitoring component 925 as described with reference to FIG. 9.

At 1110, the method may include decoding system information associated with the SSB in accordance with the first set of resources. The operations of 1110 may be performed in accordance with examples as disclosed herein. In some examples, aspects of the operations of 1110 may be performed by a decoding component 930 as described with reference to FIG. 9.

At 1115, the method may include performing a cell acquisition procedure based on the system information. The operations of 1115 may be performed in accordance with examples as disclosed herein. In some examples, aspects of the operations of 1115 may be performed by a cell acquisition component 935 as described with reference to FIG. 9.

The following provides an overview of aspects of the present disclosure:
Aspect 1: A method for wireless communications at a UE, comprising: monitoring a first set of resources for an SSB based at least in part on a capability of the UE, wherein the first set of resources is different from a second set of resources allocated for one or more wireless devices having a different capability than the capability of the UE; decoding system information associated with the SSB in accordance with the first set of resources; and performing a cell acquisition procedure based at least in part on the system information.
Aspect 2: The method of aspect 1, wherein monitoring the first set of resources for the SSB comprises: monitoring a first subset of resources corresponding to a first SSB occasion, the first subset of resources spanning one or more resource blocks associated with frequencies greater than a center frequency of a synchronization raster point for SSB monitoring, wherein a quantity of the first subset of resources is based at least in part on the capability of the UE; and monitoring a second subset of resources corresponding to a second SSB occasion, the second subset of resources spanning one or more resource blocks associated with frequencies less than the center frequency of the synchronization raster point for SSB monitoring, wherein a quantity of the second subset of resources is based at least in part on the capability of the UE.
Aspect 3: The method of any of aspects 1 through 2, further comprising: receiving a portion of an PSS, a portion of a conjugate PSS, a portion of an SSS, and a portion of a conjugate SSS based at least in part on the monitoring, wherein the portion of the PSS and the portion of the conjugate PSS comprise a complete PSS, and wherein the portion of the SSS and the portion of the conjugate SSS comprise a complete SSS.
Aspect 4: The method of aspect 1, further comprising: receiving an PSS via a plurality of contiguous symbols of the SSB; receiving an SSS via a first plurality of non-contiguous symbols of the SSB; and receiving a PBCH via a second plurality of non-contiguous symbols of the SSB different from the first plurality of non-contiguous symbols.
Aspect 5: The method of aspect 1, further comprising: receiving an PSS via a first plurality of contiguous symbols of the SSB; receiving an SSS via a second plurality of contiguous symbols of the SSB; and receiving a PBCH via a third plurality of contiguous symbols of the SSB, wherein the first plurality of contiguous symbols, the second plurality of contiguous symbols, and the third plurality of contiguous symbols are different.
Aspect 6: The method of aspect 1, further comprising: receiving an PSS via a first plurality of contiguous symbols of the SSB; receiving an SSS via a second plurality of contiguous symbols of the SSB; and receiving a PBCH via a plurality of non-contiguous symbols of the SSB, wherein the first plurality of contiguous symbols is different from the second plurality of contiguous symbols.
Aspect 7: The method of aspect 1, further comprising: receiving a PBCH via a plurality of non-contiguous symbols of the SSB, wherein at least a portion of the plurality of non-contiguous symbols are separated within an SSB occasion of the SSB by one or more empty symbols.
Aspect 8: The method of aspect 1, further comprising: receiving a PBCH via a plurality of non-contiguous symbols of the SSB and a plurality of contiguous symbols of the SSB, wherein the plurality of contiguous symbols occupies a half of an SSB occasion of the SSB in time.
Aspect 9: The method of any of aspects 1 through 8, wherein monitoring the first set of resources further comprises: monitoring six resource blocks at an SCS of 15 kHz for the SSB based at least in part on the capability of the UE.
Aspect 10: The method of any of aspects 1 through 9, wherein a synchronization raster point of the SSB is based at least in part on a bandwidth associated with the SSB.
Aspect 11: The method of any of aspects 1 through 10, wherein a synchronization raster point of the SSB is based at least in part on the capability of the UE.
Aspect 12: The method of any of aspects 1 through 11, wherein the UE is an MTC UE.
Aspect 13: A UE for wireless communications, comprising one or more memories storing processor-executable code, and one or more processors coupled with the one or more memories and individually or collectively operable to execute the code to cause the UE to perform a method of any of aspects 1 through 12.
Aspect 14: A UE for wireless communications, comprising at least one means for performing a method of any of aspects 1 through 12.
Aspect 15: A non-transitory computer-readable medium storing code for wireless communications, the code comprising instructions executable by one or more processors to perform a method of any of aspects 1 through 12.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
monitor a first set of resources for a synchronization signal block (SSB) based at least in part on a capability of the UE, wherein the first set of resources is different from a second set of resources allocated for one or more wireless devices having a different capability than the capability of the UE;
decode system information associated with the SSB in accordance with the first set of resources; and
perform a cell acquisition procedure based at least in part on the system information.

2. The UE of claim 1, wherein, to monitor the first set of resources for the SSB, the one or more processors are individually or collectively operable to execute the code to cause the UE to:
monitor a first subset of resources corresponding to a first SSB occasion, the first subset of resources spanning one or more resource blocks associated with frequencies greater than a center frequency of a synchronization raster point for SSB monitoring, wherein a quantity of the first subset of resources is based at least in part on the capability of the UE; and
monitor a second subset of resources corresponding to a second SSB occasion, the second subset of resources spanning one or more resource blocks associated with frequencies less than the center frequency of the synchronization raster point for SSB monitoring, wherein a quantity of the second subset of resources is based at least in part on the capability of the UE.

3. The UE of claim 1, wherein the one or more processors are individually or collectively further operable to execute the code to cause the UE to:
receive a portion of a primary synchronization signal (PSS), a portion of a conjugate PSS, a portion of a secondary synchronization signal (SSS), and a portion of a conjugate SSS based at least in part on the monitoring, wherein the portion of the PSS and the portion of the conjugate PSS comprise a complete PSS, and wherein the portion of the SSS and the portion of the conjugate SSS comprise a complete SSS.

4. The UE of claim 1, wherein the one or more processors are individually or collectively further operable to execute the code to cause the UE to:
receive a primary synchronization signal (PSS) via a plurality of contiguous symbols of the SSB;
receive a secondary synchronization signal (SSS) via a first plurality of non-contiguous symbols of the SSB; and
receive a physical broadcast channel (PBCH) via a second plurality of non-contiguous symbols of the SSB different from the first plurality of non-contiguous symbols.

5. The UE of claim 1, wherein the one or more processors are individually or collectively further operable to execute the code to cause the UE to:
receive a primary synchronization signal (PSS) via a first plurality of contiguous symbols of the SSB;
receive a secondary synchronization signal (SSS) via a second plurality of contiguous symbols of the SSB; and
receive a physical broadcast channel (PBCH) via a third plurality of contiguous symbols of the SSB, wherein the first plurality of contiguous symbols, the second plurality of contiguous symbols, and the third plurality of contiguous symbols are different.

6. The UE of claim 1, wherein the one or more processors are individually or collectively further operable to execute the code to cause the UE to:
receive a primary synchronization signal (PSS) via a first plurality of contiguous symbols of the SSB;
receive a secondary synchronization signal (SSS) via a second plurality of contiguous symbols of the SSB; and
receive a physical broadcast channel (PBCH) via a plurality of non-contiguous symbols of the SSB, wherein the first plurality of contiguous symbols is different from the second plurality of contiguous symbols.

7. The UE of claim 1, wherein the one or more processors are individually or collectively further operable to execute the code to cause the UE to:
receive a physical broadcast channel (PBCH) via a plurality of non-contiguous symbols of the SSB, wherein at least a portion of the plurality of non-contiguous symbols are separated within an SSB occasion of the SSB by one or more empty symbols.

8. The UE of claim 1, wherein the one or more processors are individually or collectively further operable to execute the code to cause the UE to:
receive a physical broadcast channel (PBCH) via a plurality of non-contiguous symbols of the SSB and a plurality of contiguous symbols of the SSB, wherein the plurality of contiguous symbols occupies a half of an SSB occasion of the SSB in time.

9. The UE of claim 1, wherein, to monitor the first set of resources, the one or more processors are individually or collectively further operable to execute the code to cause the UE to:
monitor six resource blocks at a subcarrier spacing of 15 kilohertz (kHz) for the SSB based at least in part on the capability of the UE.

10. The UE of claim 1, wherein a synchronization raster point of the SSB is based at least in part on a bandwidth associated with the SSB.

11. The UE of claim 1, wherein a synchronization raster point of the SSB is based at least in part on the capability of the UE.

12. The UE of claim 1, wherein the UE is a machine type communication (MTC) UE.

13. A method for wireless communications at a user equipment (UE), comprising:
monitoring a first set of resources for a synchronization signal block (SSB) based at least in part on a capability of the UE, wherein the first set of resources is different from a second set of resources allocated for one or more wireless devices having a different capability than the capability of the UE;
decoding system information associated with the SSB in accordance with the first set of resources; and
performing a cell acquisition procedure based at least in part on the system information.

14. The method of claim 13, wherein monitoring the first set of resources for the SSB comprises:
monitoring a first subset of resources corresponding to a first SSB occasion, the first subset of resources spanning one or more resource blocks associated with frequencies greater than a center frequency of a synchronization raster point for SSB monitoring, wherein a quantity of the first subset of resources is based at least in part on the capability of the UE; and
monitoring a second subset of resources corresponding to a second SSB occasion, the second subset of resources spanning one or more resource blocks associated with frequencies less than the center frequency of the synchronization raster point for SSB monitoring, wherein a quantity of the second subset of resources is based at least in part on the capability of the UE.

15. The method of claim 13, further comprising:
receiving a portion of a primary synchronization signal (PSS), a portion of a conjugate PSS, a portion of a secondary synchronization signal (SSS), and a portion of a conjugate SSS based at least in part on the monitoring, wherein the portion of the PSS and the portion of the conjugate PSS comprise a complete PSS, and wherein the portion of the SSS and the portion of the conjugate SSS comprise a complete SSS.

16. The method of claim 13, further comprising:
receiving a primary synchronization signal (PSS) via a plurality of contiguous symbols of the SSB;
receiving a secondary synchronization signal (SSS) via a first plurality of non-contiguous symbols of the SSB; and
receiving a physical broadcast channel (PBCH) via a second plurality of non-contiguous symbols of the SSB different from the first plurality of non-contiguous symbols.

17. The method of claim 13, further comprising:
receiving a primary synchronization signal (PSS) via a first plurality of contiguous symbols of the SSB;
receiving a secondary synchronization signal (SSS) via a second plurality of contiguous symbols of the SSB; and
receiving a physical broadcast channel (PBCH) via a third plurality of contiguous symbols of the SSB, wherein the first plurality of contiguous symbols, the second plurality of contiguous symbols, and the third plurality of contiguous symbols are different.

18. The method of claim 13, further comprising:
receiving a primary synchronization signal (PSS) via a first plurality of contiguous symbols of the SSB;
receiving a secondary synchronization signal (SSS) via a second plurality of contiguous symbols of the SSB; and
receiving a physical broadcast channel (PBCH) via a plurality of non-contiguous symbols of the SSB, wherein the first plurality of contiguous symbols is different from the second plurality of contiguous symbols.

19. The method of claim 13, further comprising:
receiving a physical broadcast channel (PBCH) via a plurality of non-contiguous symbols of the SSB, wherein at least a portion of the plurality of non-contiguous symbols are separated within an SSB occasion of the SSB by one or more empty symbols.

20. The method of claim 13, further comprising:
receiving a physical broadcast channel (PBCH) via a plurality of non-contiguous symbols of the SSB and a plurality of contiguous symbols of the SSB, wherein the plurality of contiguous symbols occupies a half of an SSB occasion of the SSB in time.

21. The method of claim 13, wherein monitoring the first set of resources further comprises:
monitoring six resource blocks at a subcarrier spacing of 15 kilohertz (kHz) for the SSB based at least in part on the capability of the UE.

22. The method of claim 13, wherein a synchronization raster point of the SSB is based at least in part on a bandwidth associated with the SSB.

23. The method of claim 13, wherein a synchronization raster point of the SSB is based at least in part on the capability of the UE.

24. The method of claim 13, wherein the UE is a machine type communication (MTC) UE.

25. A non-transitory computer-readable medium storing code for wireless communications, the code comprising instructions executable by one or more processors to:
monitor a first set of resources for a synchronization signal block (SSB) based at least in part on a capability of the non-transitory computer-readable medium, wherein the first set of resources is different from a second set of resources allocated for one or more wireless devices having a different capability than the capability of the non-transitory computer-readable medium;
decode system information associated with the SSB in accordance with the first set of resources; and
perform a cell acquisition procedure based at least in part on the system information.

26. The non-transitory computer-readable medium of claim 25, wherein the instructions to monitor the first set of resources for the SSB are executable by the one or more processors to:
monitor a first subset of resources corresponding to a first SSB occasion, the first subset of resources spanning one or more resource blocks associated with frequencies greater than a center frequency of a synchronization raster point for SSB monitoring, wherein a quantity of the first subset of resources is based at least in part on the capability of the non-transitory computer-readable medium; and
monitor a second subset of resources corresponding to a second SSB occasion, the second subset of resources spanning one or more resource blocks associated with frequencies less than the center frequency of the synchronization raster point for SSB monitoring, wherein a quantity of the second subset of resources is based at least in part on the capability of the non-transitory computer-readable medium.

27. The non-transitory computer-readable medium of claim 25, wherein the instructions to monitor the first set of resources are further executable by the one or more processors to:
monitor six resource blocks at a subcarrier spacing of 15 kilohertz (kHz) for the SSB based at least in part on the capability of the non-transitory computer-readable medium.

28. The non-transitory computer-readable medium of claim 25, wherein a synchronization raster point of the SSB is based at least in part on a bandwidth associated with the SSB.

29. The non-transitory computer-readable medium of claim 25, wherein a synchronization raster point of the SSB is based at least in part on the capability of the non-transitory computer-readable medium.

30. The non-transitory computer-readable medium of claim 25, wherein the non-transitory computer-readable medium is a machine type communication (MTC) UE.
